(19) United States
(12) Patent Application Publication
(10) Pub. No.: US 2020/0104714 A1
(43) Pub. Date: Apr. 2, 2020

(54) SYSTEM AND METHOD FOR DEEP REINFORCEMENT LEARNING USING CLUSTERED EXPERIENCE REPLAY MEMORY

(71) Applicant: Electronics and Telecommunications Research Institute, Daejeon (KR)

(72) Inventor: Yong Jin LEE, Daejeon (KR)

(73) Assignee: Electronics and Telecommunications Research Institute, Daejeon (KR)

(21) Appl. No.: 16/700,238

(22) Filed: Dec. 2, 2019

(30) Foreign Application Priority Data
Oct. 1, 2018 (KR) 10-2018-0116995

(51) Int. Cl. G06N 3/08; G06N 3/04

(52) U.S. Cl. CPC G06N 3/08; G06N 20/00; G06N 3/0454

(57) ABSTRACT

Provided is a deep reinforcement learning system using clustered experience replay memories, including a clustering module configured to form learning data into groups, experience replay memories generated as a result of the grouping, and a target network configured to generate a target value for learning of a learning network using learning data extracted from the experience replay memories.

### CROSS-REFERENCE TO RELATED APPLICATION

This application claims priority to and the benefit of Korean Patent Application No. 2018-0116995, filed on Oct. 1, 2018, the disclosure of which is incorporated herein by reference in its entirety.

### BACKGROUND

### 1. Field of the Invention

The present invention relates to a system and method for deep reinforcement learning using clustered experience replay memories.

### 2. Discussion of Related Art

Deep reinforcement learning according to the related art is a learning method that combines deep neural network technology with reinforcement learning technology.

A deep reinforcement learning algorithm according to the related art only discloses randomly selecting data from an experience replay memory and using the data for learning, or selecting learning data according to a temporal difference (TD) error value, but there is a limitation in directly suggesting information about which aspect of an action taken by an agent has been appropriate.

### SUMMARY OF THE INVENTION

The present invention provides a system and method for performing deep reinforcement learning by considering which aspect of an action taken by an agent has been appropriate or whether the action has led to a higher sum of reward values.

The technical objectives of the present invention are not limited to the above, and other objectives may become apparent to those of ordinary skill in the art based on the following description.

According to one aspect of the present invention, there is provided a deep reinforcement learning system using clustered experience replay memories, including a clustering module configured to form learning data into groups, experience replay memories generated as a result of the grouping by the clustering module, and a target network configured to generate a target value for learning of a learning network using learning data extracted from the experience replay memory.

According to another aspect of the present invention, there is provided a deep reinforcement learning method using clustered experience replay memories, including receiving learning data and clustering the initial learning data, performing learning on a classifier using a result of the clustering, calculating an estimated value of a sum of reward values on the basis of an action of an agent, and storing the estimated value in experience replay memories, and extracting the learning data from the experience replay memories and generating a target value for learning with a learning network.

### BRIEF DESCRIPTION OF THE DRAWINGS

FIG. 1 is a block diagram illustrating a reinforcement learning system using Deep Q-Network (DQN) according to the related art.

FIG. 2 is a block diagram illustrating a deep reinforcement learning system using a clustered experience replay memory according an embodiment of the present invention.

FIG. 3 is a diagram illustrating clustering of initial learning data of a deep reinforcement learning system using clustered experience replay memories according to an embodiment of the present invention.

FIG. 4 is a diagram illustrating a selection weight for an estimated value of the sum of reward values according to an embodiment of the present invention.

FIG. 5 is a flowchart showing a deep reinforcement learning method using clustered experience replay memories according to an embodiment of the present invention.

FIG. 6 is a view illustrating an example of a computer system in which a method according to an embodiment of the present invention is performed.

### DETAILED DESCRIPTION OF EXEMPLARY EMBODIMENTS

Hereinafter, the above and other objectives, advantages and features of the present invention and methods of achieving them will become readily apparent with reference to descriptions of the following detailed embodiments when considered in conjunction with the accompanying drawings

However, the present invention is not limited to such embodiments and may be embodied in various forms. The embodiments to be described below are provided only to assist those skilled in the art in fully understanding the objectives, configurations, and the effects of the invention, and the scope of the present invention is defined only by the appended claims.

Meanwhile, terms used herein are used to aid in the explanation and understanding of the embodiments and are not intended to limit the scope and spirit of the present invention. It should be understood that the singular forms “a,” “an,” and “the” also include the plural forms unless the context clearly dictates otherwise. The terms “comprises,” “comprising,” “includes,” and/or “including,” when used herein, specify the presence of stated features, integers, steps, operations, elements, components and/or groups thereof and do not preclude the presence or addition of one or more other features, integers, steps, operations, elements, components, and/or groups thereof.

Hereinafter, the background will be described first in order to aid those skilled in the art to understand the present invention, and then the embodiments of the present invention will be described.

Machine learning is a technology that provides information regarding prediction, classification, and pattern analysis through data-based learning and inference on the basis of a given goal.

Reinforcement learning, as a subfield of the above-described machine learning, is a learning method which differs from supervised learning, where output (target or label) for input is clearly given, in that learning is performed through trial and error by feeding back a reward that is a short-term measure of an agent's action.

The agent learns not to select an action having a large short-term reward value, which is immediately obtainable, but to take an action maximizing the sum of reward values (a state value, a state-action value) in the long run.

Deep reinforcement learning is a learning method combining deep neural network technology with reinforcement learning technology according to the related art.

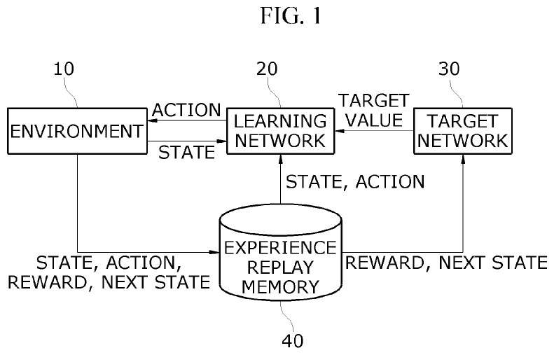

Referring to FIG. 1, as a representative deep reinforcement learning algorithm, Deep Q-Network (DQN), developed by DeepMind, is mainly characterized in using an experience replay memory 40 (referred to as a replay memory, an experience replay memory, or an replay buffer) and a target network 30 to stably perform learning on a deep neural network in a frame of a reinforcement learning.

In the DQN, a learning agent (corresponding to a learning network 20 in FIG. 1) does not immediately use data (or experience) acquired through interaction with an environment 10 for learning but stores the data in the experience replay memory 40 such that the data is randomly selected and used for learning.

The above-described DQN operates by randomly selecting data from the experience replay memory 40 and using the selected data for learning, and in this regard, a conventional technology for prioritizing and selectively using data to improve data utilization and learning performance has been proposed.

In this case, when a temporal difference (TD) error that is a difference between a predicted value of a learning network and a predicted value of a target network is larger, the data is more frequently selected and used for learning.

The above-described conventional technology, in both cases of selecting data randomly and selecting learning data with a priority according to a TD error, there is a limitation in directly suggesting information about which aspect of an action taken by a learning agent has been appropriate (that is, whether the action has maximized the sum of reward values).

This is also a fundamental limitation of the conventional reinforcement learning described above, because the conventional reinforcement learning method finds a good action through trial and error, by chance, and merely allows the action to be repeatedly performed.

The present invention is proposed to address the above-described limitation of the conventional deep reinforcement learning technology, provides a system and method for deep reinforcement learning using clustered experience replay memories in consideration of which aspect of an action taken by an agent has been appropriate or whether the action has led to a higher sum of reward values, and improves a learning method based on an experience replay memory to improve reinforcement learning performance.

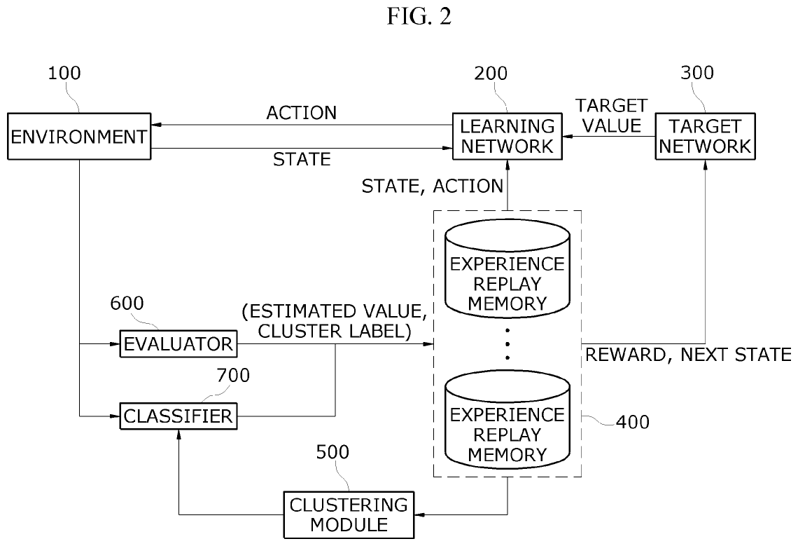

FIG. 2 is a block diagram illustrating a deep reinforcement learning system using clustered experience replay memories according an embodiment of the present invention.

The deep reinforcement learning system using the clustered experience replay memories according to the embodiment of the present invention includes a clustering module 500 configured to form learning data into groups (clustering), an experience replay memory 400 generated as a result of the grouping by the clustering module 500, and a target network 300 configured to generate a target value for learning of a learning network.

The clustering module 500 according to the embodiment of the present invention controls merging, splitting, and generating of the groups according to similarity of the groups, size of the groups, and an input of new data.

According to the embodiment of the present invention, the deep reinforcement learning system may include an evaluator 600 configured to estimate the sum of reward values on the basis of an agent's action, and also the learning network 200 or the target network 300 may calculate an estimated value of the sum of reward values of a state or action.

The learning network 200 according to the embodiment of the present invention includes a deep neural network and receives a state to output an action.

Alternatively, the learning network 200 receives a state, calculates an estimated value of the sum of reward values for each selectable action, selects an appropriate action on the basis of the estimated sum of the reward values for each action, and outputs the selected action.

Alternatively, the learning network 200 receives a state and an action, calculates an estimated value of the sum of reward values obtainable from the state and the action, selects an appropriate action on the basis of the estimated sum of the reward values for each action, and outputs the selected action.

The target network 300 according to the embodiment of the present invention has the same structure as that of the learning network 200 and is generated by periodically copying the learning network 200 during learning.

The target network 300 estimates the sum of reward values for a next state subsequent to a state and combines a reward value for the state with the estimated sum of reward values to generate a target value for learning the learning network 200.

Learning data according to the embodiment of the present invention includes a state, an action, a reward, a next state.

The clustering module 500 according to the embodiment of the present invention periodically performs clustering on data given at the beginning of learning or data (a state) stored in the experience replay memory to generate groups (or clusters).

According to the embodiment of the present invention, experience replay memories 400 are generated as many as the number of groups (or clusters) generated by the clustering module 500.

Alternatively, the experience replay memory 400 may be provided using one memory, and each piece of data may be stored along with cluster information (a label) thereof in the experience replay memory 400.

Referring to FIG. 2, the experience replay memories 400 according to the embodiment of the present invention are generated as many as the number of groups set by the clustering module 500.

The cluster information (a cluster label) according to the embodiment of the present invention is generated by a classifier 700 or the clustering module 500, and data is stored in the corresponding experience replay memory 400 according to the cluster information.

In this case, as shown in FIG. 2, the estimated value of the sum of the reward values generated by the evaluator 600 is also stored along with the individual piece of data in the experience replay memory 400.

The evaluator 600 according to the embodiment of the present invention performs evaluation on data including a state, an action, a reward, and a next state as described above.

The evaluator 600 calculates an estimated value for the sum of reward values that may be obtained starting from a state.

The evaluator 600 according to the embodiment of the present invention may be configured as a separate module as shown in FIG. 2, and it is possible to use the learning network 200 or the target network 300 when the learning network 200 or the target network 300 calculates the sum of reward values of the state or action.

The classifier 700 according to the embodiment of the present invention determines a group among preset groups, to which new data generated by the interaction between the learning network 200 (a learning agent) and an environment 100 belongs.

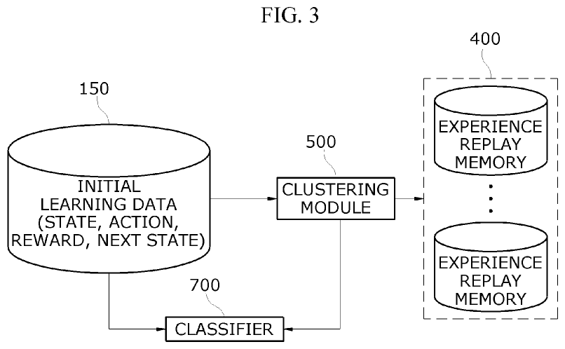

FIG. 3 illustrates clustering of initial learning data of a deep reinforcement learning system using clustered experience replay memories according to an embodiment of the present invention.

Referring to FIG. 3, initial learning data 150 is given at the beginning of learning for the first time.

The initial learning data 150 is generated by randomly selecting an agent's action.

The clustering module 500 divides input data (specifically, states) into a plurality of groups when a sufficient predetermined amount (for example, 50,000 pieces of data) of the data is collected.

Examples of an algorithm usable as the clustering module 500 according to the embodiment of the present invention may include a k-means algorithm, a fuzzy k-means algorithm, a k-medoids algorithm, a hierarchical clustering algorithm, a density-based spatial clustering of applications with noise (DBScan) algorithm, and a hierarchical DBScan (HDBScan) algorithm, but the aspect of the present invention is not limited to the specific clustering algorithms.

An initial value for the estimated value of the sum of reward values may be replaced with a reward value (corresponding to a reward among four values of a state, an action, a reward, and a next state).

Using the result of clustering, learning is performed on the classifier 700 configured to classify new data.

For example, learning may be performed on the classifier using a class label in supervised learning as the cluster information (a label). Examples of the applicable classifier may include support vector machines (SVMs), a decision tree, random forests, deep neural networks, and the like, but the aspect of the present invention is not limited to the specific classifier algorithms.

As an example of a simple configuration, when the clustering module 500 uses the K-means algorithm, the classifier 700 may be configured by simply maintaining the average value of each cluster. That is, when unlabeled data is input, a distance between the average value of each cluster and the input data may be calculated and the input data may be classified into a cluster having an average value at the nearest distance.

Referring again to FIG. 2, after the initial setting described above, new data (a state, an action, a reward, and a next state) is generated through the interaction between the learning network 200 and the environment 100.

The classifier 700 determines a group among the divided groups, to which the new data belongs, and stores the new data in the experience replay memory 400.

In this case, the new data is stored along with an estimated value of the sum of reward values calculated by the evaluator 600 in the experience replay memory 400.

The target network 300 generates a target value for learning of the learning network 200 using learning data extracted from the experience replay memory 400.

According to the embodiment of the present invention, unlike the conventional technology of randomly selecting learning data from one experience replay memory, data is selected according to the estimated value of the sum of reward values in each of a plurality of experience replay memories (or groups or clusters).

In the selecting of the data, data whose estimated value of the sum of reward values is large and data whose estimated value of the sum of reward values is small are selected together in each experience replay memory.

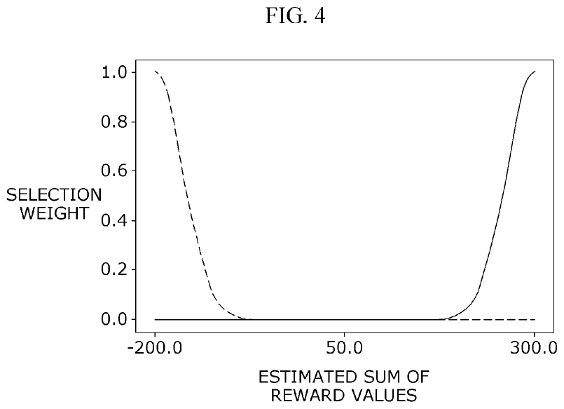

According to the embodiment of the present invention, pieces of data having been collected so far have a range from the minimum sum of reward values of −200 to the maximum sum of reward values of 300, and a selection weight is non-linearly calculated such that the minimum sum and the maximum sum have a value close to 1, and the remainder has a relatively smaller value (or less than 1) as shown in FIG. 4.

According to the embodiment of the present invention, data is selected according to the selection weight.

However, data stored in the same experience replay memory 400 has a similar state by the clustering module 500 and the classifier 700.

Accordingly, data having a small sum of reward values and data having a large sum of reward values are divided in terms of actions according to the embodiment of the present invention.

That is, since learning is performed by contrasting an action leading to a large sum of reward values and an action leading to a small sum of reward values in a similar situation, reinforcement learning is performed in consideration of which aspect of an action has been appropriate or whether the action has led to a higher sum of reward values.

The evaluator 600 for estimating the sum of reward values according to the embodiment of the present invention may be provided as a separate module as described above, and it is also possible to use the learning network 200 or the target network 300.

When the learning network 200 or the target network 300 is used for the evaluator 600, the learning network 200 or the target network 300 serves to estimate the sum of reward values for a state-action pair or a state.

Alternatively, in data given as a state, an action, a reward, and a next state, a partial sum of reward values obtained by recording some operations subsequent to the state may be used.

According to the embodiment of the present invention, new data is generated through the interaction between the learning network and the environment, and the data is stored in a corresponding experience replay memory, and is selected in consideration of the sum of reward values and is used for learning.

Since new learning data is added while the above-described processes proceed, the clustering module 500 according to the embodiment of the present invention periodically performs the clustering process, accordingly the classifier 700 is also newly subjected to learning.

According to the embodiment of the present invention, the clustering module 500 may perform clustering in the form of batch learning by gathering data having been collected so far at regular intervals or perform online clustering.

For example, when the K-means algorithm is used, the present invention, in response to new data being input, determines a group to which the data belongs and updates the average value of the group by reflecting the newly stored data.

In any case of the batch type clustering or the online type clustering, the number of clusters may vary depending on the situation.

When groups (clusters) are similar to each other, for example, when the averages of groups (clusters) are significantly close to each other in the case of using the K-means algorithm, the clustering module 500 combines and merges the similar groups (clusters) into one group (one cluster).

When the size of a specific group (a cluster) is large (the number of pieces of data belonging to the cluster is large), the clustering module 500 divides the group into two or more groups (clusters).

When new data markedly different from a preset group (a cluster) is input, the clustering module 500 may generate a new cluster.

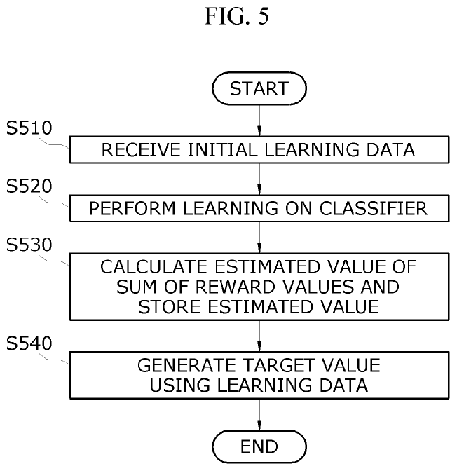

FIG. 5 is a flowchart showing a deep reinforcement learning method using clustered experience replay memories according to an embodiment of the present invention.

The deep reinforcement learning method using clustered experience replay memories according to the embodiment of the present invention includes receiving learning data and clustering the learning data (S510), performing learning on a classifier using a result of the clustering (S520), calculating an estimated value of the sum of reward values on the basis of an action of an agent, and storing the estimated value of the sum of reward values in an experience replay memory (S530), and extracting learning data from the experience replay memory and generating a target value for learning (S540).

In operation S510, experience replay memories are generated as many as the number of clusters resulting from the clustering.

According to an embodiment of the present invention, it is also possible that the experience replay memories may not be generated as many as the number of the clusters but data may be stored together with cluster information (a label).

In operation S520, the classifier may be subjected to learning through a supervised learning method using a cluster label or may be subjected to learning such that an average value for each of the clusters is maintained according to a K-means algorithm performed in operation S510.

In operation S530, evaluation is performed on data including a state, an action, a reward, and a next state, and the sum of reward values obtainable starting from the state is estimated.

In operation S540, the learning data is extracted in consideration of a selection weight for the sum of the reward values.

According to the embodiment of the present invention, data for learning is selected according to the estimated value of the sum of reward values in each of the plurality of experience replay memories (or groups or clusters), and in this case, data whose estimated value of the sum of reward values is large and data whose estimated value of the sum of reward values is small are selected together in each experience replay memory.

This is to non-linearly extract learning data in consideration of a selection weight as shown in FIG. 4.

In this way, data having a small sum of reward values and data having a large sum of reward values are divided in terms of the actions according to the embodiment of the present invention, so that learning is performed by contrasting an action leading to a large sum of reward values and an action leading to a small sum of reward values in a similar situation, and therefore reinforcement learning is performed considering which aspect of an action has been appropriate or whether the action has led to a higher sum of reward values.

The deep reinforcement learning method may further include storing new data generated by the interaction of the agent and an environment in the experience replay memory, periodically performing the clustering, and performing re-learning on the classifier.

In order to more clearly describe the subject matter concept of the present invention, control and management of building energy will be described below as an example of embodiment. In the example, the environment may be a building subjected to management and control, and the state may include indoor and outdoor temperature and humidity, indoor carbon dioxide concentration, occupant distribution or absence/presence, insolation, airflow, and the like, that are measurable by sensors installed inside and outside the building. The action may include control signals for devices that may affect the indoor environment, such as air conditioner temperature setting, humidifier operation or non-operation, electric awning control, and the like. The reward value may be provided using a combination of energy costs used to control the building environment and the occupant comfort. For example, as the amount of energy use increases, the reward value is set to be low, and as the indoor temperature and humidity the occupant feels comfortable are maintained, the reward value is set to be high. Predicted mean vote (PMV) is widely used as a criterion for evaluating the occupant comfort in building energy management systems (BEMS). In the set-up described above, the agent of reinforcement learning learns a policy that may control the building as high the occupant comfort as possible using as little energy cost as possible. In this case, according to the aspect of the present invention, when the clustering module is used for the agent learning, state information is classified according to indoor and outdoor conditions of the building. For example, on the basis of seasons, a small or large amount of solar radiation, low or high density of the occupants, or other various indoor and outdoor environment conditions, the state information is clustered and classified. Accordingly, the reinforcement learning agent according to the aspect of the present invention uses an appropriate action and an inappropriate action for each of the indoor and outdoor environment conditions as the learning data. For example, in summer conditions having high indoor temperature and high indoor humidity, a case in which the air conditioner temperature is set to be high at 30 degrees and a case in which the air conditioner temperature is appropriately set to 25 degrees are learned, so that more rapid and efficient learning may be achieved. As another example, when an occupant does not exist, a case in which the air conditioner is operated and a case in which the air conditioner is not operated are contrasted and learned. The case of the air conditioner operated with no occupant is considered a case in which energy is wasted without having substantial improvement of the occupant comfort due to absence of the occupant.

In order to more clearly describe the subject matter concept of the present invention, control and management of an intersection signal will be described below as an example of the embodiment. In the example, the environment may be an intersection in which traffic lights subjected to management and control are installed, and the state may include a traffic condition of the surrounding of the intersection, for example, traffic information that is measurable by sensors installed on the intersection or roads around the intersection, such as the number of vehicles waiting in each lane, the average waiting time of vehicles, and the travel speed of vehicles on the roads around the intersection, and weather information (e.g., snow or rain) that may affect a traffic flow. In addition, since traffic flow patterns are different between a commute time and other times, it is desirable to use the commute time zone or the current time as environmental information. The action may include control of a cycle length of a signal, control of a split, and the like. The cycle length is a length of the time required for a complete cycle of traffic light indications and is usually expressed in seconds. The split is a value of an effective green time (an actual length of green time used) of a phase i divided by the cycle length C. The reward value may be provided using the average waiting time of vehicles at an intersection, the size of the waiting line, the average passage speed of the roads around the intersection, and the like. In the set-up described above, the agent of the reinforcement learning learns a policy that may control the signal cycle or the phase such that the waiting time at the intersection is shortened or the traffic of the roads around the intersection becomes smooth. Here, according to the aspect of the present invention, when the clustering module is used for the agent learning, state information is classified according to the conditions of the intersection and the roads around the intersection. For example, on the basis of raining or snowing, whether it is a commute time zone or not, clustering, and other various environment conditions, the state information is clustered and classified. Accordingly, the reinforcement learning agent according to the aspect of the present invention uses an appropriate action and an inappropriate action for each of the environment conditions of the intersection and the road around the intersection as the learning data. For example, with regard to a rainy situation, a cycle length determined to be appropriate and a cycle length determined to be inappropriate are contrasted and learned, so that more rapid and efficient learning may be achieved. As another example, with regard to a commute time zone, splits determined to be appropriate and splits determined to be inappropriate are contrasted and learned, so that so that more rapid and efficient learning may be achieved.

As is apparent from the above, deep reinforcement learning considering which aspect of an action taken by an agent has been appropriate or whether the action has led to a higher sum of reward values can be performed, and when selecting learning data from an experience replay memory, learning is performed by contrasting an action having a larger sum of reward values with an action having a smaller sum of rewards in a similar situation, and thus more efficient reinforcement learning can be achieved.

The effects of the present invention are not limited to the above description, and the other effects that are not described may be clearly understood by those skilled in the art from the detailed description.

Although the present invention has been described with reference to the embodiments, a person of ordinary skill in the art should appreciate that various modifications, equivalents, and other embodiments are possible without departing from the scope and sprit of the present invention. Therefore, the embodiments disclosed above should be construed as being illustrative rather than limiting the present invention. The scope of the present invention is not defined by the above embodiments but by the appended claims of the present invention, and the present invention is to cover all modifications, equivalents, and alternatives falling within the spirit and scope of the present invention.

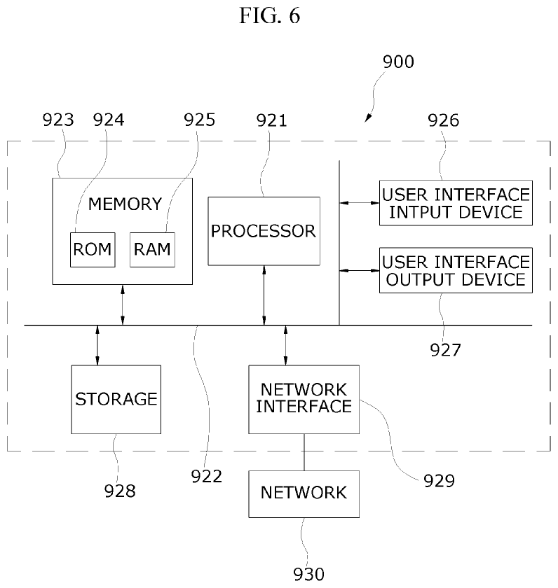

The method according to an embodiment of the present invention may be implemented in a computer system or may be recorded in a recording medium. FIG. 6 illustrates a simple embodiment of a computer system. As illustrated, the computer system may include one or more processors 921, a memory 923, a user input device 926, a data communication bus 922, a user output device 927, a storage 928, and the like. These components perform data communication through the data communication bus 922. Also, the computer system may further include a network interface 929 coupled to a network. The processor 921 may be a central processing unit (CPU) or a semiconductor device that processes a command stored in the memory 923 and/or the storage 928. The memory 923 and the storage 928 may include various types of volatile or non-volatile storage mediums. For example, the memory 923 may include a ROM 924 and a RAM 925. Thus, the method according to an embodiment of the present invention may be implemented as a method that can be executable in the computer system. When the method according to an embodiment of the present invention is performed in the computer system, computer-readable commands may perform the producing method according to the present invention.

What is claimed is:

1. A deep reinforcement learning system using clustered experience replay memories, comprising:
a clustering module configured to form learning data into groups;
experience replay memories generated as a result of the grouping by the clustering module; and
a target network configured to generate a target value for learning of a learning network using learning data extracted from the experience replay memories.

2. The deep reinforcement learning system of claim 1, wherein the clustering module periodically forms the learning data and data stored in the experience replay memories into groups.

3. The deep reinforcement learning system of claim 1, wherein the clustering module controls merging, splitting, and generating of the groups according to a similarity of the group, a size of the group, and an input of new data.

4. The deep reinforcement learning system of claim 1, wherein the experience replay memories are generated as many as a number of the groups generated by the clustering module.

5. The deep reinforcement learning system of claim 1, wherein the experience replay memory stores data along with cluster information accompanying the data.

6. The deep reinforcement learning system of claim 1, wherein the learning network includes a deep neural network, receives a state and calculate an estimated value of a sum of reward values of each selectable action, selects an appropriate action in consideration of the estimated sum of the reward values of each action, and outputs the selected appropriate action.

7. The deep reinforcement learning system of claim 1, wherein the learning network is configured to receive a state and an action, calculate an estimated value of a sum of reward values obtainable from the state and the action, select an appropriate action in consideration of the estimated sum of the reward values for each action, and output the selected appropriate action.

8. The deep reinforcement learning system of claim 1, wherein the target network uses the learning data that is selected in each of the experience replay memories in consideration of a selection weight for the sum of the reward values.

9. The deep reinforcement learning system of claim 1, wherein the target network estimates a sum of reward values of a next state subsequent to a state and combines a reward value of the state with the estimated sum of the reward values to generate a target value for learning of the learning network.

10. The deep reinforcement learning system of claim 1, further comprising an evaluator configured to estimate a sum of reward values on the basis of an action of an agent.

11. The deep reinforcement learning system of claim 1, further comprising a classifier configured to identify a group to which new data generated by an interaction between the learning network and an environment belongs.

12. A deep reinforcement learning method using clustered experience replay memories, comprising:
(a) receiving learning data and clustering the initial learning data;
(b) performing learning on a classifier using a result of the clustering;
(c) calculating an estimated value of a sum of reward values on the basis of an action of an agent, and storing the estimated value in experience replay memories; and
(d) extracting the learning data from the experience replay memories and generating a target value for learning with a learning network.

13. The deep reinforcement learning method of claim 12, wherein step (a) comprises generating the experience replay memories as many as a number of clusters resulting from the clustering.

14. The deep reinforcement learning method of claim 12, wherein step (b) comprises performing learning on the classifier through a supervised learning method using a cluster label or performing learning on the classifier such that an average value for each of the clusters is maintained according to a K-means algorithm performed in step (a).

15. The deep reinforcement learning method of claim 12, wherein step (c) comprises performing evaluation on data including a state, an action, a reward, and a next state to estimate the sum of reward values obtainable starting from the state.

16. The deep reinforcement learning method of claim 12, wherein step (d) comprises extracting the learning data in consideration of a selection weight for the sum of the reward values.

17. The deep reinforcement learning method of claim 12, further comprising (e) storing new data generated by an interaction between the agent and an environment in the experience replay memory, periodically performing the clustering, and performing re-learning on the classifier.

18. The deep reinforcement learning method of claim 17, wherein step (e) comprises performing merging, splitting, and generating of the clusters according to a similarity of the cluster, a size of the cluster, and an input of new data.
